(19) United States
(12) Patent Application Publication
(10) Pub. No.: US 2026/0267740 A1
(43) Pub. Date: Sep. 10, 2026

(54) DEFECT MITIGATION FOR FAILED BYTE COUNTER CIRCUITS IN A MEMORY DEVICE

(71) Applicant: Micron Technology, Inc., Boise, ID (US)

(72) Inventors: Alex Sheng-Huang Lee, Meridian, ID (US); Jason Lee Nevill, Boise, ID (US); Luyen Vu, San Jose, CA (US); Trismardawi Tanadi, Folsom, CA (US); Sead Zildzic, JR., Folsom, CA (US); Surenendranath C. Eruvuru, Boise, ID (US); Hope Abigail Hatfield, Boise, ID (US)

(21) Appl. No.: 19/555,800

(22) Filed: Mar. 3, 2026

Related U.S. Application Data
(60) Provisional application No. 63/768,053, filed on Mar. 6, 2025.

(51) Int. Cl. G06F 11/10

(52) U.S. Cl. CPC G06F 11/1076

(57) ABSTRACT

A memory device includes a memory array having a plurality of segments, a page buffer circuit with a plurality of failed byte counter circuits corresponding to the plurality of segments and control logic to configure the page buffer circuit to enable a first subset of the plurality of failed byte counter circuits, identify one or more failed byte counter circuits in the first subset that are defective, disable the one or more failed byte counter circuits in the first subset that are defective, and enable one or more failed byte counter circuits in a second subset of the plurality of failed byte counter circuits.

### RELATED APPLICATIONS

This application claims the benefit of priority from U.S. Provisional Patent Application No. 63/768,053, filed March 6, 2025, which is incorporated herein by reference.

### TECHNICAL FIELD

Embodiments of the disclosure relate generally to memory sub-systems, and more specifically, relate to defect mitigation for failed byte counter circuits in a memory device of a memory sub-system.

### BACKGROUND

A memory sub-system can include one or more memory devices that store data. The memory devices can be, for example, non-volatile memory devices and volatile memory devices. In general, a host system can utilize a memory sub-system to store data at the memory devices and to retrieve data from the memory devices.

### BRIEF DESCRIPTION OF THE DRAWINGS

The present disclosure will be understood more fully from the detailed description given below and from the accompanying drawings of various embodiments of the disclosure.

FIG. 1A illustrates an example computing system that includes a memory sub-system in accordance with some embodiments of the present disclosure.

FIG. 1B is a block diagram of a memory device in communication with a memory sub-system controller of a memory sub-system, in accordance with some embodiments of the present disclosure.

FIG. 2 is a schematic of portions of an array of memory cells as could be used in a memory of the type described with reference to FIG. 1B in accordance with some embodiments of the present disclosure.

FIG. 3 is a flow diagram of an example method of performing defect mitigation for failed byte counter circuits in a memory device in accordance with some embodiments of the present disclosure.

FIG. 4 is a block diagram illustrating defect mitigation for failed byte counter circuits in a memory device in accordance with some embodiments of the present disclosure.

FIG. 5 is a block diagram of an example computer system in which embodiments of the present disclosure can operate.

### DETAILED DESCRIPTION

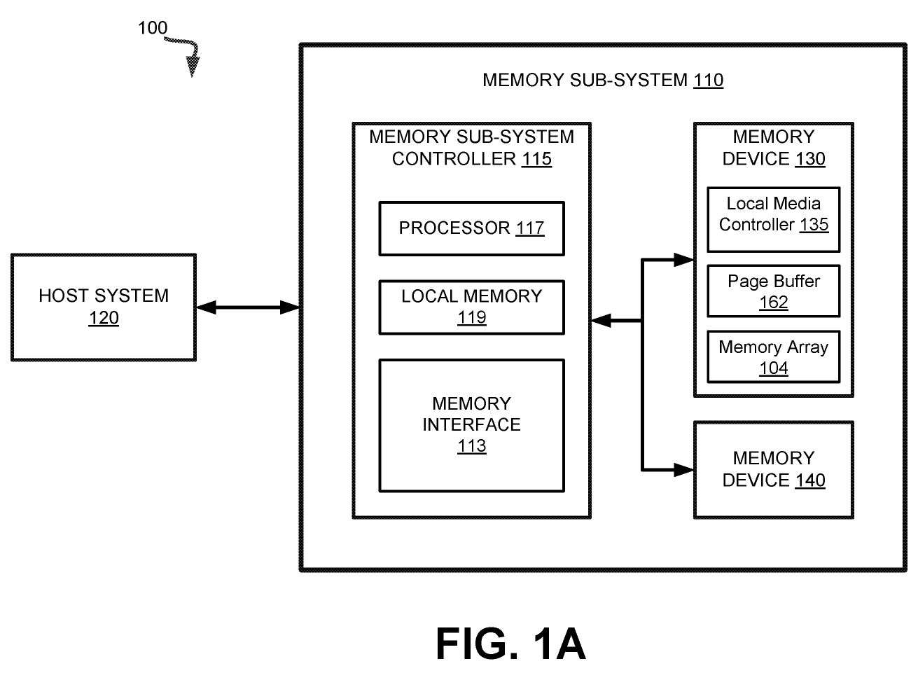

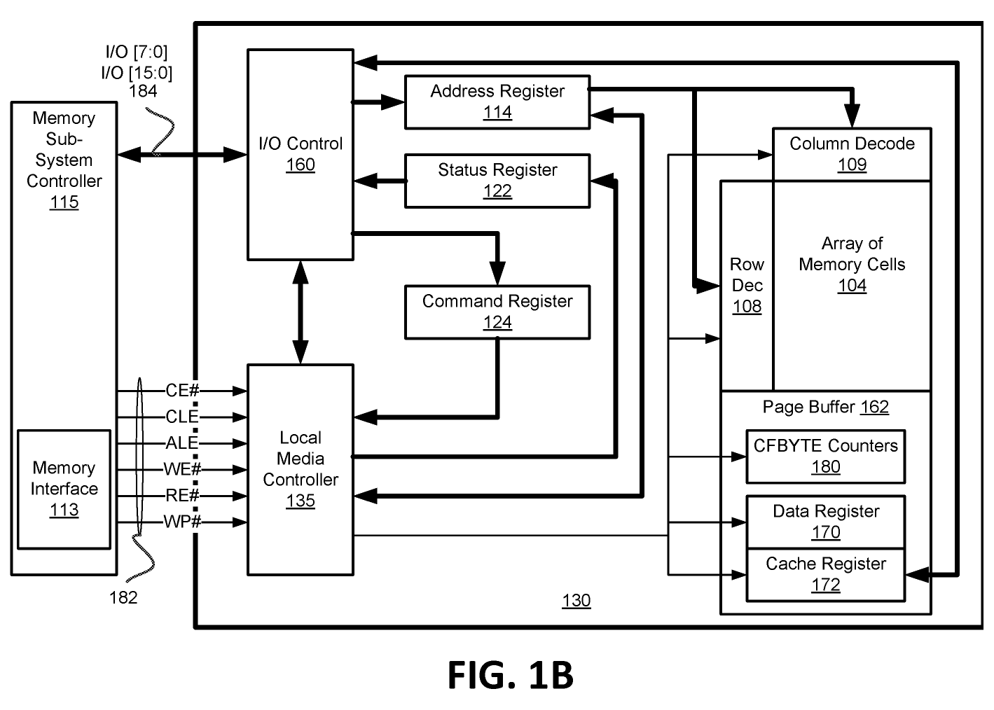

Aspects of the present disclosure are directed to defect mitigation for failed byte counter circuits in a memory device of a memory sub-system. A memory sub-system can be a storage device, a memory module, or a hybrid of a storage device and memory module. Examples of storage devices and memory modules are described below in conjunction with FIG. 1A. In general, a host system can utilize a memory sub-system that includes one or more components, such as memory devices that store data. The host system can provide data to be stored at the memory sub-system and can request data to be retrieved from the memory sub-system.

A memory sub-system can include high density non-volatile memory devices where retention of data is desired when no power is supplied to the memory device. For example, NAND memory, such as 3D flash NAND memory, offers storage in the form of compact, high-density configurations. A non-volatile memory device is a package of one or more dice, each including one or more planes. For some types of non-volatile memory devices (e.g., NAND memory), each plane includes a set of physical blocks. Each block includes a set of pages. Each page includes a set of memory cells (“cells”). A cell is an electronic circuit that stores information. Depending on the cell type, a cell can store one or more bits of binary information, and has various logic states that correlate to the number of bits being stored. The logic states can be represented by binary values, such as “0” and “1”, or combinations of such values.

A memory device can be made up of bits arranged in a two-dimensional or a three-dimensional grid. Memory cells are formed onto a silicon wafer in an array of columns (also hereinafter referred to as bit lines) and rows (also hereinafter referred to as wordlines). A wordline can refer to one or more rows of memory cells of a memory device that are used with one or more bit lines to generate the address of each of the memory cells. The intersection of a bit line and wordline constitutes the address of the memory cell. A block hereinafter refers to a unit of the memory device used to store data and can include a group of memory cells, a wordline group, a wordline, or individual memory cells. One or more blocks can be grouped together to form separate partitions (e.g., planes) of the memory device in order to allow concurrent operations to take place on each plane. The memory device can include circuitry that performs concurrent memory page accesses of two or more memory planes. For example, the memory device can include multiple access line driver circuits and power circuits that can be shared by the planes of the memory device to facilitate concurrent access of pages of two or more memory planes, including different page types. Each data block can include a number of sub-blocks, where each sub-block is defined by an associated pillar (e.g., a vertical conductive trace) extending from a shared bitline. Memory pages (also referred to herein as “pages”) store one or more bits of binary data corresponding to data received from the host system. To achieve high density, a string of memory cells in a non-volatile memory device can be constructed to include a number of memory cells at least partially surrounding a pillar of channel material. The memory cells can be coupled to access lines, which are commonly referred to as “wordlines,” often fabricated in common with the memory cells, so as to form an array of strings in a block of memory. The compact nature of certain non-volatile memory devices, such as 3D flash NAND memory, means wordlines are common to many memory cells within a block of memory.

In addition to the memory array itself, a memory device further includes a number of peripheral circuits disposed adjacent or in proximity to the memory array. For example, a memory device can include signal drivers, registers, sense circuitry, page buffers, counters, etc. which may be implemented using complementary metal oxide semiconductor (CMOS) technology. One example of this peripheral CMOS circuitry includes a digital count fail byte (CFBYTE) counter, which may be included within a page buffer circuit. CFBYTE counters (also referred to herein failed byte counter circuits) may be used during program and erase algorithms executed on the memory device to track the number of bytes that are incorrectly programmed in a given segment (e.g., a plane) of the memory device. For example, the CFBYTE counters can be incremented when a program failure is detected in the corresponding segments. When the cumulative value of the CFBYTE counters reaches a given threshold, it may indicate that the error correction capability of the memory device has been met or exceeded.

In order to decrease the overall size of a memory device without decreasing the available storage capacity, minimizing the size of the peripheral CMOS circuitry becomes increasingly important. Certain memory device attempt to reduce the size of the peripheral CMOS circuitry by decreasing the spacing (i.e., pitch) between circuit elements (also known as pitch doubling). The circuitry in pitch double areas, however, is more error prone and more likely to suffer defects and/or failure. For critical circuitry, such as CFBYTE counters, such errors can result in the entire memory device being discarded, which significantly hurts the manufacturing yield of such memory devices.

Aspects of the present disclosure address the above and other deficiencies by implementing defect mitigation for failed byte (CFBYTE) counter circuits in a memory device of a memory sub-system. For example the memory device may have a page buffer circuit coupled to the memory array and including a plurality of failed byte counter circuits, where each failed byte counter circuit is associated with a corresponding segment or physical partition (e.g., a sub-block) of the memory array. In one embodiment, processing logic on the memory device, or in an external device coupled to the memory device can configure the page buffer circuit to enable a first subset of the plurality of failed byte counter circuits. For example, only 50% or 75% of the failed byte counter circuits may be enabled, while a remainder of the failed byte counter circuits provide redundancy for the first subset. If the processing logic identifies one or more failed byte counter circuits in the first subset that are defective, the processing logic can disable those failed byte counter circuits and enable one or more failed byte counter circuits in a second subset (i.e., the remainder) of the plurality of failed byte counter circuits. Memory access operation can subsequently be performed on the memory device using the enabled failed byte counter circuits.

Advantages of this approach include, but are not limited to, improved performance in the memory device. The ability to replace defective failed byte counter circuits with functional circuits allows for the peripheral CMOS circuitry to be fabricated using the pitch doubling techniques, which results in a smaller overall memory device size without sacrificing storage capacity. Since there is a near uniform distribution for the probability of error across the segments of the memory device, enabling only a portion (i.e., the first subset) of the failed byte counter circuits does not hinder performance of memory access operations in the memory device and allows for the remainder of the failed byte counter circuits to provide redundancy in the event of any defects. This can increase yield in the memory device manufacturing process and also improve reliability of the memory device.

FIG. 1A illustrates an example computing system 100 that includes a memory sub-system 110 in accordance with some embodiments of the present disclosure. The memory sub-system 110 can include media, such as one or more volatile memory devices (e.g., memory device 140), one or more non-volatile memory devices (e.g., memory device 130), or a combination of such.

A memory sub-system 110 can be a storage device, a memory module, or a hybrid of a storage device and memory module. Examples of a storage device include a solid-state drive (SSD), a flash drive, a universal serial bus (USB) flash drive, an embedded Multi-Media Controller (eMMC) drive, a Universal Flash Storage (UFS) drive, a secure digital (SD) card, and a hard disk drive (HDD). Examples of memory modules include a dual in-line memory module (DIMM), a small outline DIMM (SO-DIMM), and various types of non-volatile dual in-line memory modules (NVDIMMs).

The computing system 100 can be a computing device such as a desktop computer, laptop computer, network server, mobile device, a vehicle (e.g., airplane, drone, train, automobile, or other conveyance), Internet of Things (IoT) enabled device, embedded computer (e.g., one included in a vehicle, industrial equipment, or a networked commercial device), or such computing device that includes memory and a processing device.

The computing system 100 can include a host system 120 that is coupled to one or more memory sub-systems 110. In some embodiments, the host system 120 is coupled to different types of memory sub-system 110. FIG. 1A illustrates one example of a host system 120 coupled to one memory sub-system 110. As used herein, “coupled to” or “coupled with” generally refers to a connection between components, which can be an indirect communicative connection or direct communicative connection (e.g., without intervening components), whether wired or wireless, including connections such as electrical, optical, magnetic, etc.

The host system 120 can include a processor chipset and a software stack executed by the processor chipset. The processor chipset can include one or more cores, one or more caches, a memory controller (e.g., NVDIMM controller), and a storage protocol controller (e.g., PCIe controller, SATA controller, CXL controller). The host system 120 uses the memory sub-system 110, for example, to write data to the memory sub-system 110 and read data from the memory sub-system 110.

The host system 120 can be coupled to the memory sub-system 110 via a physical host interface. Examples of a physical host interface include, but are not limited to, a serial advanced technology attachment (SATA) interface, a compute express link (CXL) interface, a peripheral component interconnect express (PCIe) interface, universal serial bus (USB) interface, Fibre Channel, Serial Attached SCSI (SAS), a double data rate (DDR) memory bus, Small Computer System Interface (SCSI), a dual in-line memory module (DIMM) interface (e.g., DIMM socket interface that supports Double Data Rate (DDR)), etc. The physical host interface can be used to transmit data between the host system 120 and the memory sub-system 110. The host system 120 can further utilize an NVM Express (NVMe) interface to access the memory components (e.g., memory devices 130) when the memory sub-system 110 is coupled with the host system 120 by the physical host interface (e.g., PCIe or CXL interface). The physical host interface can provide an interface for passing control, address, data, and other signals between the memory sub-system 110 and the host system 120. FIG. 1A illustrates a memory sub-system 110 as an example. In general, the host system 120 can access multiple memory sub-systems via a same communication connection, multiple separate communication connections, and/or a combination of communication connections.

The memory devices 130, 140 can include any combination of the different types of non-volatile memory devices and/or volatile memory devices. The volatile memory devices (e.g., memory device 140) can be, but are not limited to, random access memory (RAM), such as dynamic random access memory (DRAM) and synchronous dynamic random access memory (SDRAM).

Some examples of non-volatile memory devices (e.g., memory device 130) include not-and (NAND) type flash memory and write-in-place memory, such as three-dimensional cross-point (“3D cross-point”) memory. A cross-point array of non-volatile memory can perform bit storage based on a change of bulk resistance, in conjunction with a stackable cross-gridded data access array. Additionally, in contrast to many flash-based memories, cross-point non-volatile memory can perform a write in-place operation, where a non-volatile memory cell can be programmed without the non-volatile memory cell being previously erased. NAND type flash memory includes, for example, two-dimensional NAND (2D NAND) and three-dimensional NAND (3D NAND).

Each of the memory devices 130 can include one or more arrays of memory cells. One type of memory cell, for example, single level cells (SLC) can store one bit per cell. Other types of memory cells, such as multi-level cells (MLCs), triple level cells (TLCs), and quad-level cells (QLCs), can store multiple bits per cell. In some embodiments, each of the memory devices 130 can include one or more arrays of memory cells such as SLCs, MLCs, TLCs, QLCs, or any combination of such. In some embodiments, a particular memory device can include an SLC portion, and an MLC portion, a TLC portion, or a QLC portion of memory cells. The memory cells of the memory devices 130 can be grouped as pages that can refer to a logical unit of the memory device used to store data. With some types of memory (e.g., NAND), pages can be grouped to form blocks.

Although non-volatile memory components such as a 3D cross-point array of non-volatile memory cells and NAND type flash memory (e.g., 2D NAND, 3D NAND) are described, the memory device 130 can be based on any other type of non-volatile memory, such as read-only memory (ROM), phase change memory (PCM), self-selecting memory, other chalcogenide based memories, ferroelectric transistor random-access memory (FeTRAM), ferroelectric random access memory (FeRAM), magneto random access memory (MRAM), Spin Transfer Torque (STT)-MRAM, conductive bridging RAM (CBRAM), resistive random access memory (RRAM), oxide based RRAM (OxRAM), not-or (NOR) flash memory, electrically erasable programmable read-only memory (EEPROM).

A memory sub-system controller 115 (or controller 115 for simplicity) can communicate with the memory devices 130 to perform operations such as reading data, writing data, or erasing data at the memory devices 130 and other such operations. The memory sub-system controller 115 can include hardware such as one or more integrated circuits and/or discrete components, a buffer memory, or a combination thereof. The hardware can include a digital circuitry with dedicated (i.e., hard-coded) logic to perform the operations described herein. The memory sub-system controller 115 can be a microcontroller, special purpose logic circuitry (e.g., a field programmable gate array (FPGA), an application specific integrated circuit (ASIC), etc.), or other suitable processor.

The memory sub-system controller 115 can include a processor 117 (e.g., a processing device) configured to execute instructions stored in a local memory 119. In the illustrated example, the local memory 119 of the memory sub-system controller 115 includes an embedded memory configured to store instructions for performing various processes, operations, logic flows, and routines that control operation of the memory sub-system 110, including handling communications between the memory sub-system 110 and the host system 120.

In some embodiments, the local memory 119 can include memory registers storing memory pointers, fetched data, etc. The local memory 119 can also include read-only memory (ROM) for storing micro-code. While the example memory sub-system 110 in FIG. 1A has been illustrated as including the memory sub-system controller 115, in another embodiment of the present disclosure, a memory sub-system 110 does not include a memory sub-system controller 115, and can instead rely upon external control (e.g., provided by an external host, or by a processor or controller separate from the memory sub-system).

In general, the memory sub-system controller 115 can receive commands or operations from the host system 120 and can convert the commands or operations into instructions or appropriate commands to achieve the desired access to the memory devices 130. The memory sub-system controller 115 can be responsible for other operations such as wear leveling operations, garbage collection operations, error detection and error-correcting code (ECC) operations, encryption operations, caching operations, and address translations between a logical address (e.g., logical block address (LBA), namespace) and a physical address (e.g., physical block address) that are associated with the memory devices 130. The memory sub-system controller 115 can further include host interface circuitry to communicate with the host system 120 via the physical host interface. The host interface circuitry can convert the commands received from the host system into command instructions to access the memory devices 130 as well as convert responses associated with the memory devices 130 into information for the host system 120.

The memory sub-system 110 can also include additional circuitry or components that are not illustrated. In some embodiments, the memory sub-system 110 can include a cache or buffer (e.g., DRAM) and address circuitry (e.g., a row decoder and a column decoder) that can receive an address from the memory sub-system controller 115 and decode the address to access the memory devices 130.

In some embodiments, the memory devices 130 include local media controllers 135 that operate in conjunction with memory sub-system controller 115 to execute operations on one or more memory cells of the memory devices 130. An external controller (e.g., memory sub-system controller 115) can externally manage the memory device 130 (e.g., perform media management operations on the memory device 130). In some embodiments, a memory device 130 is a managed memory device, which is a raw memory device 130 having control logic (e.g., local controller 135) on the die and a controller (e.g., memory sub-system controller 115) for media management within the same memory device package. An example of a managed memory device is a managed NAND (MNAND) device. Memory device 130, for example, can represent a single die having some control logic (e.g., local media controller 135) embodied thereon. In some embodiments, one or more components of memory sub-system 110 can be omitted.

In one embodiment, the memory sub-system 110 includes a memory interface 113 that is responsible for handling interactions of memory sub-system controller 115 with the memory devices of memory sub-system 110, such as memory device 130. For example, the memory interface 113 can send memory access commands corresponding to requests received from host system 120 to memory device 130, such as program commands, read commands, or other commands. In addition, the memory interface 113 can receive data from memory device 130, such as data retrieved in response to a read command or a confirmation that a program command was successfully performed. In some embodiments, the memory sub-system controller 115 includes at least a portion of the memory interface 113. For example, the memory sub-system controller 115 can include a processor 117 (processing device) configured to execute instructions stored in local memory 119 for performing the operations described herein.

In one embodiment, memory device 130 includes a page buffer circuit 162 coupled to memory array 104. The page buffer circuit 162 may include numerous registers and other circuity, such as a number of failed byte counter circuits, which may be used to perform memory access operations on memory array 104. In one embodiment, the page buffer circuit 162 and the failed byte counter circuits included therein, are controlled by on-die control logic, such as local media controller 135. In one embodiment each failed byte counter circuit is associated with a corresponding segment or physical partition (e.g., a sub-block) of the memory array 104. As described herein, the local media controller 135, or an external device such as host system 120, can configure the page buffer circuit 162 to enable a first subset of the plurality of failed byte counter circuits. For example, only 50% or 75% of the failed byte counter circuits may be enabled, while a remainder of the failed byte counter circuits provide redundancy for the first subset. If the local media controller 135 identifies one or more failed byte counter circuits in the first subset that are defective, the local media controller 135 can disable those failed byte counter circuits and enable one or more failed byte counter circuits in a second subset (i.e., the remainder) of the plurality of failed byte counter circuits. The local media controller 135 can subsequently perform memory access operation on the memory array 104 using the enabled failed byte counter circuits. Further details are provided below.

FIG. 1B is a simplified block diagram of a first apparatus, in the form of a memory device 130, in communication with a second apparatus, in the form of a memory sub-system controller 115 of a memory sub-system (e.g., memory sub-system 110 of FIG. 1A), according to an embodiment. Some examples of electronic systems include personal computers, personal digital assistants (PDAs), digital cameras, digital media players, digital recorders, games, appliances, vehicles, wireless devices, mobile telephones and the like. The memory sub-system controller 115 (e.g., a controller external to the memory device 130), may be a memory controller or other external host device. In one embodiment, memory sub-system controller 115 includes memory interface 113.

Memory device 130 includes an array of memory cells 104 logically arranged in rows and columns. Memory cells of a logical row are typically connected to the same access line (e.g., a wordline) while memory cells of a logical column are typically selectively connected to the same data line (e.g., a bit line). A single access line may be associated with more than one logical row of memory cells and a single data line may be associated with more than one logical column. Memory cells (not shown in FIG. 1B) of at least a portion of array of memory cells 104 are capable of being programmed to one of at least two target data states.

Row decode circuitry 108 and column decode circuitry 109 are provided to decode address signals. Address signals are received and decoded to access the array of memory cells 104. Memory device 130 also includes input/output (I/O) control circuitry 160 to manage input of commands, addresses and data to the memory device 130 as well as output of data and status information from the memory device 130. An address register 114 is in communication with I/O control circuitry 160 and row decode circuitry 108 and column decode circuitry 109 to latch the address signals prior to decoding. A command register 124 is in communication with I/O control circuitry 160 and local media controller 135 to latch incoming commands.

A controller (e.g., the local media controller 135 internal to the memory device 130) controls access to the array of memory cells 104 in response to the commands and generates status information for the external memory sub-system controller 115, i.e., the local media controller 135 is configured to perform access operations (e.g., read operations, programming operations and/or erase operations) on the array of memory cells 104. The local media controller 135 is in communication with row decode circuitry 108 and column decode circuitry 109 to control the row decode circuitry 108 and column decode circuitry 109 in response to the addresses.

The local media controller 135 is also in communication with a cache register 172. Cache register 172 latches data, either incoming or outgoing, as directed by the local media controller 135 to temporarily store data while the array of memory cells 104 is busy writing or reading, respectively, other data. During a program operation (e.g., write operation), data may be passed from the cache register 172 to the data register 170 for transfer to the array of memory cells 104; then new data may be latched in the cache register 172 from the I/O control circuitry 160. During a read operation, data may be passed from the cache register 172 to the I/O control circuitry 160 for output to the memory sub-system controller 115; then new data may be passed from the data register 170 to the cache register 172. The cache register 172 and/or the data register 170 may form (e.g., may form a portion of) a page buffer 162 of the memory device 130. The page buffer 162 may further include sensing devices (not shown in FIG. 1B) to sense a data state of a memory cell of the array of memory cells 104 (e.g., by sensing a state of a data line connected to that memory cell) and a number of failed byte counter circuits (CFBYTE counters 180). The failed byte counter circuits each correspond to a respective physical segments of the memory array 104 and are used during program and erase algorithms executed on the memory device 130 to track the number of bytes that are incorrectly programmed in a given segment (e.g., a plane) of the memory device. A status register 122 may be in communication with I/O control circuitry 160 and the local memory controller 135 to latch the status information for output to the memory sub-system controller 115.

Memory device 130 receives control signals at the memory sub-system controller 115 from the local media controller 135 over a control link 182. For example, the control signals can include a chip enable signal CE#, a command latch enable signal CLE, an address latch enable signal ALE, a write enable signal WE#, a read enable signal RE#, and a write protect signal WP#. Additional or alternative control signals (not shown) may be further received over control link 182 depending upon the nature of the memory device 130. In one embodiment, memory device 130 receives command signals (which represent commands), address signals (which represent addresses), and data signals (which represent data) from the memory sub-system controller 115 over a multiplexed input/output (I/O) bus 184 and outputs data to the memory sub-system controller 115 over I/O bus 184.

For example, the commands may be received over input/output (I/O) pins [7:0] of I/O bus 184 at I/O control circuitry 160 and may then be written into command register 124. The addresses may be received over input/output (I/O) pins [7:0] of I/O bus 184 at I/O control circuitry 160 and may then be written into address register 114. The data may be received over input/output (I/O) pins [7:0] for an 8-bit device or input/output (I/O) pins [15:0] for a 16-bit device at I/O control circuitry 160 and then may be written into cache register 172. The data may be subsequently written into data register 170 for programming the array of memory cells 104.

In an embodiment, cache register 172 may be omitted, and the data may be written directly into data register 170. Data may also be output over input/output (I/O) pins [7:0] for an 8-bit device or input/output (I/O) pins [15:0] for a 16-bit device. Although reference may be made to I/O pins, they may include any conductive node providing for electrical connection to the memory device 130 by an external device (e.g., the memory sub-system controller 115), such as conductive pads or conductive bumps as are commonly used.

It will be appreciated by those skilled in the art that additional circuitry and signals can be provided, and that the memory device 130 of FIG. 1B has been simplified. It should be recognized that the functionality of the various block components described with reference to FIG. 1B may not necessarily be segregated to distinct components or component portions of an integrated circuit device. For example, a single component or component portion of an integrated circuit device could be adapted to perform the functionality of more than one block component of FIG. 1B. Alternatively, one or more components or component portions of an integrated circuit device could be combined to perform the functionality of a single block component of FIG. 1B. Additionally, while specific I/O pins are described in accordance with popular conventions for receipt and output of the various signals, it is noted that other combinations or numbers of I/O pins (or other I/O node structures) may be used in the various embodiments.

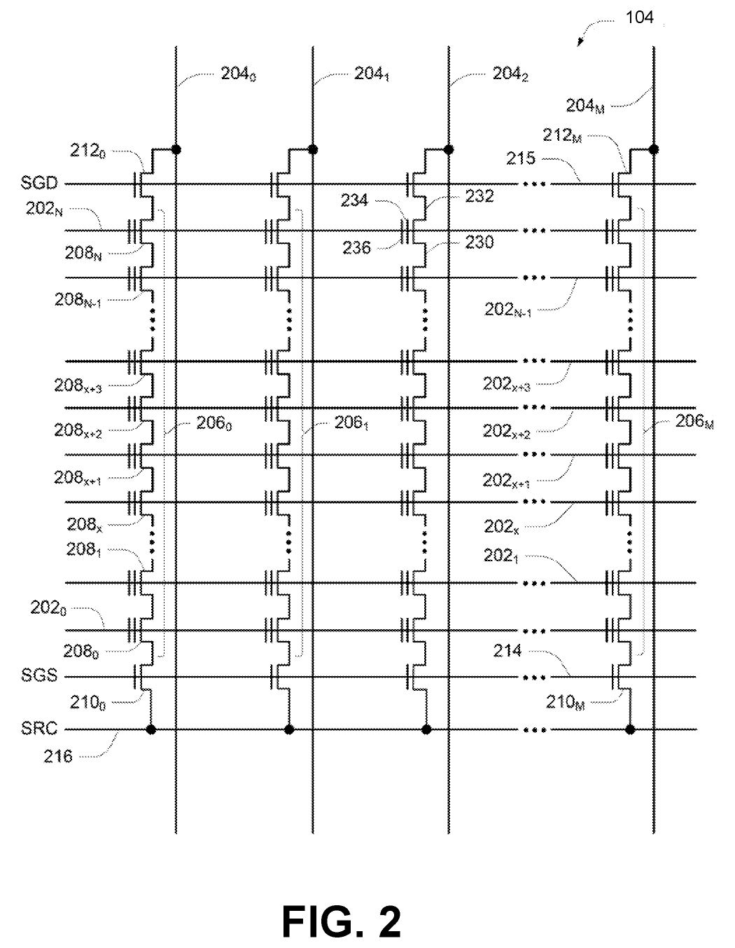

FIG. 2 is a schematic of portions of an array of memory cells 104, such as a NAND memory array, as could be used in a memory of the type described with reference to FIG. 1B according to an embodiment. Memory array 104 includes access lines, such as wordlines 202₀to 202_{N}, and data lines, such as bit lines 204₀to 204_{M}. The wordlines 202 can be connected to global access lines (e.g., global wordlines), not shown in FIG. 2, in a many-to-one relationship. For some embodiments, memory array 104 can be formed over a semiconductor that, for example, can be conductively doped to have a conductivity type, such as a p-type conductivity, e.g., to form a p-well, or an n-type conductivity, e.g., to form an n-well.

Memory array 104 can be arranged in rows (each corresponding to a wordline 202) and columns (each corresponding to a bit line 204). Each column can include a string of series-connected memory cells (e.g., non-volatile memory cells), such as one of NAND strings 206₀to 206_{M}. Each NAND string 206 can be connected (e.g., selectively connected) to a common source (SRC) 216 and can include memory cells 208₀to 208_{N}. The memory cells 208 can represent non-volatile memory cells for storage of data. The memory cells 208 of each NAND string 206 can be connected in series between a select gate 210 (e.g., a field-effect transistor), such as one of the select gates 210₀to 210_{M} (e.g., that can be source select transistors, commonly referred to as select gate source), and a select gate 212 (e.g., a field-effect transistor), such as one of the select gates 212₀to 212_{M} (e.g., that can be drain select transistors, commonly referred to as select gate drain). Select gates 210₀to 210_{M} can be commonly connected to a select line 214, such as a source select line (SGS), and select gates 212₀to 212_{M} can be commonly connected to a select line 215, such as a drain select line (SGD). Although depicted as traditional field-effect transistors, the select gates 210 and 212 can utilize a structure similar to (e.g., the same as) the memory cells 208. The select gates 210 and 212 can represent a number of select gates connected in series, with each select gate in series configured to receive a same or independent control signal.

A source of each select gate 210 can be connected to common source 216. The drain of each select gate 210 can be connected to a memory cell 208₀of the corresponding NAND string 206. For example, the drain of select gate 210₀can be connected to memory cell 208₀of the corresponding NAND string 206₀. Therefore, each select gate 210 can be configured to selectively connect a corresponding NAND string 206 to the common source 216. A control gate of each select gate 210 can be connected to the select line 214.

The drain of each select gate 212 can be connected to the bit line 204 for the corresponding NAND string 206. For example, the drain of select gate 212₀can be connected to the bit line 204₀for the corresponding NAND string 206₀. The source of each select gate 212 can be connected to a memory cell 208_{N} of the corresponding NAND string 206. For example, the source of select gate 212₀can be connected to memory cell 208_{N} of the corresponding NAND string 206₀. Therefore, each select gate 212 can be configured to selectively connect a corresponding NAND string 206 to the corresponding bit line 204. A control gate of each select gate 212 can be connected to select line 215.

The memory array 104 in FIG. 2 can be a quasi-two-dimensional memory array and can have a generally planar structure, e.g., where the common source 216, NAND strings 206 and bit lines 204 extend in substantially parallel planes. Alternatively, the memory array 104 in FIG. 2 can be a three-dimensional memory array, e.g., where NAND strings 206 can extend substantially perpendicular to a plane containing the common source 216 and to a plane containing the bit lines 204 that can be substantially parallel to the plane containing the common source 216.

Typical construction of memory cells 208 includes a data-storage structure 234 (e.g., a floating gate, charge trap, and the like) that can determine a data state of the memory cell (e.g., through changes in threshold voltage), and a control gate 236, as shown in FIG. 2. The data-storage structure 234 can include both conductive and dielectric structures while the control gate 236 is generally formed of one or more conductive materials. In some cases, memory cells 208 can further have a defined source/drain (e.g., source) 230 and a defined source/drain (e.g., drain) 232. The memory cells 208 have their control gates 236 connected to (and in some cases form) a wordline 202.

A column of the memory cells 208 can be a NAND string 206 or a number of NAND strings 206 selectively connected to a given bit line 204. A row of the memory cells 208 can be memory cells 208 commonly connected to a given wordline 202. A row of memory cells 208 can, but need not, include all the memory cells 208 commonly connected to a given wordline 202. Rows of the memory cells 208 can often be divided into one or more groups of physical pages of memory cells 208, and physical pages of the memory cells 208 often include every other memory cell 208 commonly connected to a given wordline 202. For example, the memory cells 208 commonly connected to wordline 202_{N} and selectively connected to even bit lines 204 (e.g., bit lines 204₀, 204₂, 204₄, etc.) can be one physical page of the memory cells 208 (e.g., even memory cells) while memory cells 208 commonly connected to wordline 202_{N} and selectively connected to odd bit lines 204 (e.g., bit lines 204₁, 204₃, 204₅, etc.) can be another physical page of the memory cells 208 (e.g., odd memory cells).

Although bit lines 204₃-204₅are not explicitly depicted in FIG. 2, it is apparent from the figure that the bit lines 204 of the array of memory cells 104 can be numbered consecutively from bit line 204₀to bit line 204_{M}. Other groupings of the memory cells 208 commonly connected to a given wordline 202 can also define a physical page of memory cells 208. For certain memory devices, all memory cells commonly connected to a given wordline can be deemed a physical page of memory cells. The portion of a physical page of memory cells (which, in some embodiments, could still be the entire row) that is read during a single read operation or programmed during a single programming operation (e.g., an upper or lower page of memory cells) can be deemed a logical page of memory cells. A block of memory cells can include those memory cells that are configured to be erased together, such as all memory cells connected to wordlines 202₀-202_{N} (e.g., all NAND strings 206 sharing common wordlines 202). Unless expressly distinguished, a reference to a page of memory cells herein refers to the memory cells of a logical page of memory cells. Although the example of FIG. 2 is discussed in conjunction with NAND flash, the embodiments and concepts described herein are not limited to a particular array architecture or structure, and can include other structures (e.g., SONOS, phase change, ferroelectric, etc.) and other architectures (e.g., AND arrays, NOR arrays, etc.).

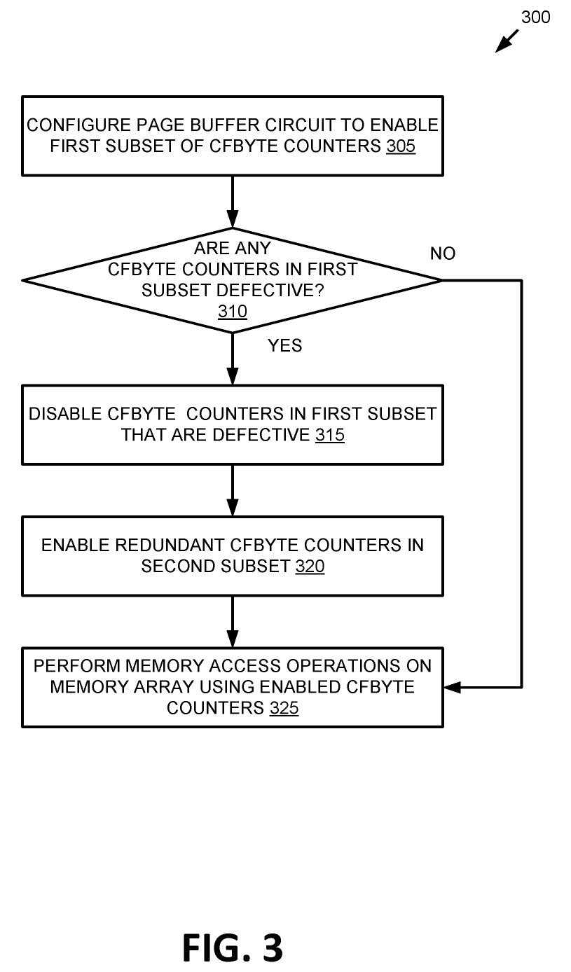

FIG. 3 is a flow diagram of an example method of performing defect mitigation for failed byte counter circuits in a memory device in accordance with some embodiments of the present disclosure. The method 300 can be performed by processing logic that can include hardware (e.g., processing device, circuitry, dedicated logic, programmable logic, microcode, hardware of a device, integrated circuit, etc.), software (e.g., instructions run or executed on a processing device), or a combination thereof. In some embodiments, the method 300 is performed by local media controller 135 of FIGS. 1A and 1B. In other embodiments, Although shown in a particular sequence or order, unless otherwise specified, the order of the processes can be modified. Thus, the illustrated embodiments should be understood only as examples, and the illustrated processes can be performed in a different order, and some processes can be performed in parallel. Additionally, one or more processes can be omitted in various embodiments. Thus, not all processes are required in every embodiment. Other process flows are possible.

At operation 305, failed byte counter circuits are configured. For example, the processing logic (e.g., local media controller 135) may configure a page buffer circuit 162 in the memory device 130 to enable a first subset of the plurality of failed byte counter circuits 180. As described above, the page buffer circuit 162 may include a number of failed byte counter circuits 180 that can be used during program and erase algorithms executed on the memory device 130 to track the number of bytes that are incorrectly programmed in a given segment of the memory device 130. For example, the failed byte counter circuits 180 can be incremented when a program failure is detected in the corresponding segments. When the cumulative value of the failed byte counter circuits 180 reaches a given threshold, it may indicate that the error correction capability of the memory device 130 has been met or exceeded.

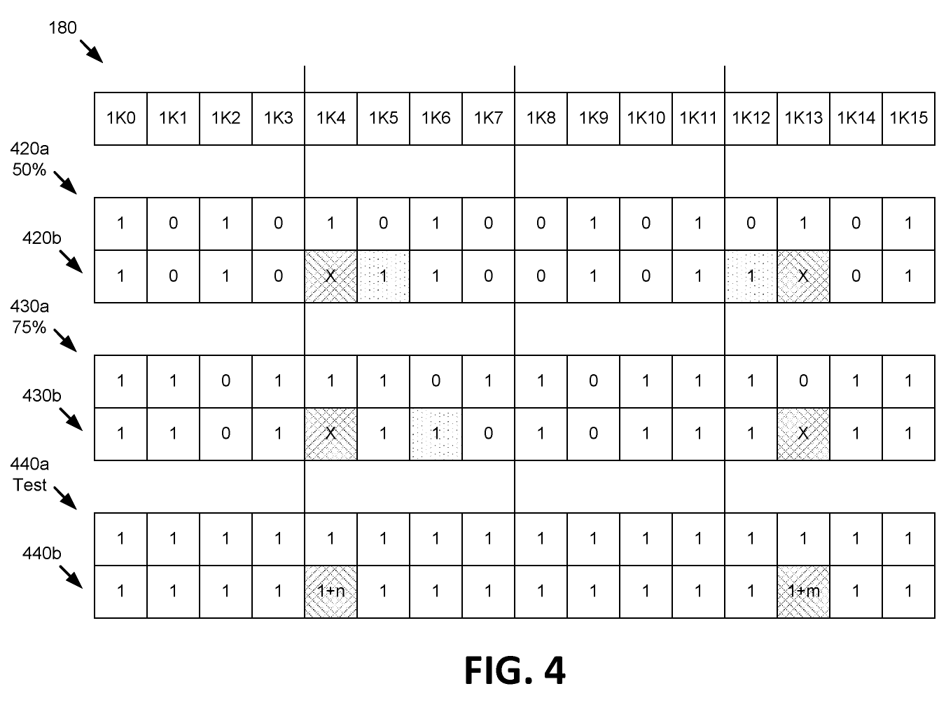

FIG. 4 is a block diagram illustrating defect mitigation for failed byte counter circuits in a memory device in accordance with some embodiments of the present disclosure. In one embodiment, the failed byte counter circuits 180 are split into 16 segments of 1 kilobyte each (i.e., 1K0-1K15) for a given plane of the memory device 130. In one embodiment, the plane has a number of individual blocks, and a number of these failed byte counter circuits 180 are associated with each block (e.g., 4 failed byte counter circuits 180 per block, or one failed byte counter circuit per sub-block). In this manner, each of the plurality of failed byte counter circuits 180 corresponds to a respective segment (i.e., a physical partition) of a plurality of segments of a memory array 104 of the memory device 130. Thus, when a programming error is detected in a given segment, the corresponding failed byte counter circuit 180 can be incremented.

In one embodiment, instead of having all 16 failed byte counter circuits 180 be enabled, only a first subset of the failed byte counter circuits 180 are enabled. In one embodiment, the processing logic may write to a control register to selectively enable the first subset. For example, row 420a illustrates an embodiment where the first subset includes 50% of the failed byte counter circuits 180 that are enabled (as indicated by a “1”). As illustrated, two of the four failed byte counter circuits associated with each block are enabled, including 1K0, 1K2, 1K4, 1K6, 1K9, 1K11, 1K13, and 1K15. In another example, row 430a illustrates an embodiment where the first subset includes 75% of the failed byte counter circuits 130 that are enabled. As illustrated, three of the four failed byte counter circuits associated with each block are enabled, including 1K0, 1K1, 1K3, 1K4, 1K5, 1K7, 1K8, 1K10, 1K11, 1K12, 1K14, and 1K15. In either embodiment, the remainder of the failed byte counter circuits 180 constitute a second subset that remains disabled (as indicated by a “0”) and provides redundancy for the first subset of the failed byte counter circuits 180. In other embodiments, the first and second subsets may include some other percentage of the failed byte counter circuits 180.

Referring again to FIG. 3, at operation 310, a determination is made. For example, the processing logic can determine whether one or more failed byte counter circuits in the first subset are defective. As part of a testing process, the local media controller 135 (or an external testing device) can identify one or more failed byte counter circuits in the first subset that are defective. For example, the processing logic can generate one or more test data patterns to cause a program failure either directly in the memory array 104 or manipulating data register 170 in the page buffer 162 (i.e., to simulate the program failure) and to cause an increment of the corresponding plurality of failed byte counter circuits 180. Upon applying the one or more test data patterns to the memory array 104, functional (i.e., non-defective) failed byte counter circuits 180 should be incremented accordingly. Thus, the processing logic can determine whether each of the failed byte counter circuits 180 has an actual value that matches an expected value (i.e., what the value should be after being incremented in view of the one or more test data patterns). If the actual value of any of the failed byte counter circuits 180 does not match the expected value, the processing logic can identify those failed byte counter circuits as being defective.

At operation 315, some failed byte counter circuits are disabled. For example, if there are one or more failed byte counter circuits in the first subset that are defective, at operation 315, the processing logic can disable the one or more failed byte counter circuits in the first subset that are defective. In one embodiment, the processing logic may write to the control register to selectively disable the defective failed byte counter circuits. According to the example in FIG. 4, row 420b and row 430b illustrate that counter 1K4 and counter 1K13 are defective and have been disabled (as indicated by the “X”).

At operation 320, redundant failed byte counter circuits are enabled. For example, the processing logic can enable one or more failed byte counter circuits in a second subset of the plurality of failed byte counter circuits. In one embodiment, the processing logic may write to the control register to selectively enable one or more redundant failed byte counter circuits that were previously not in use. According to the example in FIG. 4, row 420b illustrates that counter 1K5 and counter 1K12 have been enabled (as indicated by the “1”), and row 430b illustrates that counter 1K6 has been enabled. The newly enabled failed byte counter circuits correspond to different segments of the memory array 104 and thus represent a count of program failures in those different segments. Since there is a near uniform distribution for the probability of error across the segments, however, this change does not impact a determination of the overall reliability of the memory device represented by the cumulative value of all enabled failed byte counter circuits.

At operation 325, memory access operations are performed. For example, the processing logic can perform one or more memory access operations on the memory array 104 using the enabled failed byte counter circuits. In one embodiment, the enabled failed byte counter circuits include the functional counter circuits from the first subset, plus the newly enabled counter circuits from the second subset that were activated to replace the defective counter circuits from the first subset. If no defective counter circuits in the first subset are identified at operation 310, then the memory device 130 can be operated using the first subset. As memory access operations (e.g., program or erase operations) are performed on the memory array, the enabled failed byte counter circuits 180 can be incremented when errors are failures are detected in the corresponding segments of the memory array.

FIG. 4 further illustrates an alternative embodiment where a test mode of operation is utilized for the failed byte counter circuits 180. In this mode, all of the failed byte counter circuits 180 are enabled, as illustrated in row 440a. A similar testing operation can be performed, as described above with respect to operation 310 to identify any defective counter circuits. Since there are no redundant failed byte counter circuits, however, the defective counter circuits cannot be disabled and replaced. Instead, the processing logic can determine an offset between the actual value and the expected value of the defective counter circuits and store that offset to be used during operation of the memory device 130. For example, as illustrated in row 440b, the processing logic may determine that the counter circuit 1K4 has an offset of “n” and that counter circuit 1K13 has an offset of “m”. During operation of memory device 130, the processing logic can apply those respective offsets to the actual value of those defective counters in order to determine a corrected count value. This corrected count value can be used to assess the overall health of the memory device 130.

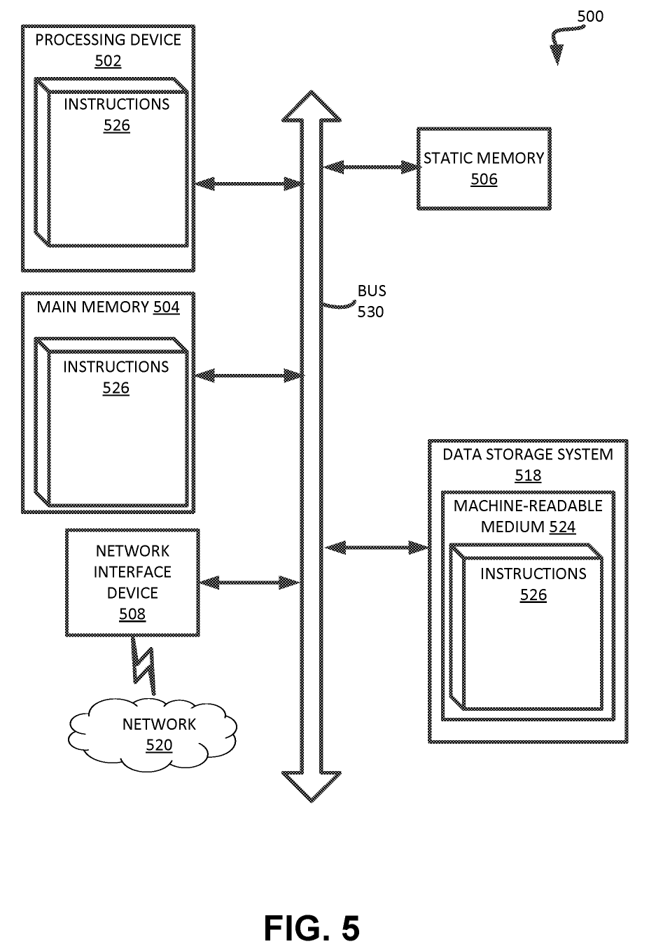

FIG. 5 illustrates an example machine of a computer system 500 within which a set of instructions, for causing the machine to perform any one or more of the methodologies discussed herein, can be executed. In some embodiments, the computer system 500 can correspond to a host system (e.g., the host system 120 of FIG. 1A) that includes, is coupled to, or utilizes a memory sub-system (e.g., the memory sub-system 110 of FIG. 1A) or can be used to perform the operations of a controller (e.g., to execute an operating system to perform operations corresponding to local media controller 135 of FIG. 1A). In alternative embodiments, the machine can be connected (e.g., networked) to other machines in a LAN, an intranet, an extranet, and/or the Internet. The machine can operate in the capacity of a server or a client machine in client-server network environment, as a peer machine in a peer-to-peer (or distributed) network environment, or as a server or a client machine in a cloud computing infrastructure or environment.

The machine can be a personal computer (PC), a tablet PC, a set-top box (STB), a Personal Digital Assistant (PDA), a cellular telephone, a web appliance, a server, a network router, a switch or bridge, or any machine capable of executing a set of instructions (sequential or otherwise) that specify actions to be taken by that machine. Further, while a single machine is illustrated, the term “machine” shall also be taken to include any collection of machines that individually or jointly execute a set (or multiple sets) of instructions to perform any one or more of the methodologies discussed herein.

The example computer system 500 includes a processing device 502, a main memory 504 (e.g., read-only memory (ROM), flash memory, dynamic random access memory (DRAM) such as synchronous DRAM (SDRAM) or Rambus DRAM (RDRAM), etc.), a static memory 506 (e.g., flash memory, static random access memory (SRAM), etc.), and a data storage system 518, which communicate with each other via a bus 530.

Processing device 502 represents one or more general-purpose processing devices such as a microprocessor, a central processing unit, or the like. More particularly, the processing device can be a complex instruction set computing (CISC) microprocessor, reduced instruction set computing (RISC) microprocessor, very long instruction word (VLIW) microprocessor, or a processor implementing other instruction sets, or processors implementing a combination of instruction sets. Processing device 502 can also be one or more special-purpose processing devices such as an application specific integrated circuit (ASIC), a field programmable gate array (FPGA), a digital signal processor (DSP), network processor, or the like. The processing device 502 is configured to execute instructions 526 for performing the operations and steps discussed herein. The computer system 500 can further include a network interface device 508 to communicate over the network 520.

The data storage system 518 can include a machine-readable storage medium 524 (also known as a computer-readable medium) on which is stored one or more sets of instructions 526 or software embodying any one or more of the methodologies or functions described herein. The instructions 526 can also reside, completely or at least partially, within the main memory 504 and/or within the processing device 502 during execution thereof by the computer system 500, the main memory 504 and the processing device 502 also constituting machine-readable storage media. The machine-readable storage medium 524, data storage system 518, and/or main memory 504 can correspond to the memory sub-system 110 of FIG. 1A.

In one embodiment, the instructions 526 include instructions to implement functionality corresponding to the local media controller 135 of FIG. 1A. While the machine-readable storage medium 524 is shown in an example embodiment to be a single medium, the term “machine-readable storage medium” should be taken to include a single medium or multiple media that store the one or more sets of instructions. The term “machine-readable storage medium” shall also be taken to include any medium that is capable of storing or encoding a set of instructions for execution by the machine and that cause the machine to perform any one or more of the methodologies of the present disclosure. The term “machine-readable storage medium” shall accordingly be taken to include, but not be limited to, solid-state memories, optical media, and magnetic media.

Some portions of the preceding detailed descriptions have been presented in terms of algorithms and symbolic representations of operations on data bits within a computer memory. These algorithmic descriptions and representations are the ways used by those skilled in the data processing arts to most effectively convey the substance of their work to others skilled in the art. An algorithm is here, and generally, conceived to be a self-consistent sequence of operations leading to a desired result. The operations are those requiring physical manipulations of physical quantities. Usually, though not necessarily, these quantities take the form of electrical or magnetic signals capable of being stored, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. The present disclosure can refer to the action and processes of a computer system, or similar electronic computing device, that manipulates and transforms data represented as physical (electronic) quantities within the computer system's registers and memories into other data similarly represented as physical quantities within the computer system memories or registers or other such information storage systems.

The present disclosure also relates to an apparatus for performing the operations herein. This apparatus can be specially constructed for the intended purposes, or it can include a general purpose computer selectively activated or reconfigured by a computer program stored in the computer. Such a computer program can be stored in a computer readable storage medium, such as, but not limited to, any type of disk including floppy disks, optical disks, CD-ROMs, and magnetic-optical disks, read-only memories (ROMs), random access memories (RAMs), EPROMs, EEPROMs, magnetic or optical cards, or any type of media suitable for storing electronic instructions, each coupled to a computer system bus.

The algorithms and displays presented herein are not inherently related to any particular computer or other apparatus. Various general purpose systems can be used with programs in accordance with the teachings herein, or it can prove convenient to construct a more specialized apparatus to perform the method. The structure for a variety of these systems will appear as set forth in the description below. In addition, the present disclosure is not described with reference to any particular programming language. It will be appreciated that a variety of programming languages can be used to implement the teachings of the disclosure as described herein.

The present disclosure can be provided as a computer program product, or software, that can include a machine-readable medium having stored thereon instructions, which can be used to program a computer system (or other electronic devices) to perform a process according to the present disclosure. A machine-readable medium includes any mechanism for storing information in a form readable by a machine (e.g., a computer). In some embodiments, a machine-readable (e.g., computer-readable) medium includes a machine (e.g., a computer) readable storage medium such as a read only memory (“ROM”), random access memory (“RAM”), magnetic disk storage media, optical storage media, flash memory components, etc.

In the foregoing specification, embodiments of the disclosure have been described with reference to specific example embodiments thereof. It will be evident that various modifications can be made thereto without departing from the broader spirit and scope of embodiments of the disclosure as set forth in the following claims. The specification and drawings are, accordingly, to be regarded in an illustrative sense rather than a restrictive sense.

What is claimed is:

1. A memory device comprising:
a memory array comprising a plurality of segments;
a page buffer circuit comprising a plurality of failed byte counter circuits corresponding to the plurality of segments; and
control logic, operatively coupled with the memory array and the page buffer circuit, to perform operations comprising:
configuring the page buffer circuit to enable a first subset of the plurality of failed byte counter circuits;
identifying one or more failed byte counter circuits in the first subset that are defective;
disabling the one or more failed byte counter circuits in the first subset that are defective; and
enabling one or more failed byte counter circuits in a second subset of the plurality of failed byte counter circuits.

2. The memory device of claim 1, wherein each of the plurality of failed byte counter circuits corresponds to a respective segment of the plurality of segments of the memory array.

3. The memory device of claim 2, wherein the plurality of segments of the memory array comprise sub-blocks of a plurality of blocks of a plane of the memory array.

4. The memory device of claim 1, wherein the first subset comprises 50% of the plurality of failed byte counter circuits.

5. The memory device of claim 1, wherein the first subset comprises 75% of the plurality of failed byte counter circuits.

6. The memory device of claim 1, wherein identifying the one or more failed byte counter circuits in the first subset that are defective comprises:
generating one or more test data patterns to cause a program failure at least one of directly in the memory array or by manipulating a data register in a page buffer associated with the memory device and to cause an increment of the plurality of failed byte counter circuits;
determining whether each of the plurality of failed byte counter circuits has an actual value that matches an expected value in view of the one or more test data patterns; and
identifying the one or more failed byte counter circuits in the first subset that are defective as those for which the actual value does not match the expected value.

7. The memory device of claim 1, wherein the control logic is to perform operations further comprising:
performing one or more memory access operations on the memory array using the enabled failed byte counter circuits.

8. A method comprising:
configuring a page buffer circuit of a memory device to enable a first subset of a plurality of failed byte counter circuits in the page buffer circuit, the plurality of failed byte counter circuits corresponding to a plurality of segments of a memory array of the memory device;
identifying one or more failed byte counter circuits in the first subset that are defective;
disabling the one or more failed byte counter circuits in the first subset that are defective; and
enabling one or more failed byte counter circuits in a second subset of the plurality of failed byte counter circuits.

9. The method of claim 8, wherein each of the plurality of failed byte counter circuits corresponds to a respective segment of the plurality of segments of the memory array.

10. The method of claim 9, wherein the plurality of segments of the memory array comprise sub-blocks of a plurality of blocks of a plane of the memory array.

11. The method of claim 8, wherein the first subset comprises 50% of the plurality of failed byte counter circuits.

12. The method of claim 8, wherein the first subset comprises 75% of the plurality of failed byte counter circuits.

13. The method of claim 8, wherein identifying the one or more failed byte counter circuits in the first subset that are defective comprises:
generating one or more test data patterns to cause a program failure at least one of directly in the memory array or by manipulating a data register in a page buffer associated with the memory device and to cause an increment of the plurality of failed byte counter circuits;
determining whether each of the plurality of failed byte counter circuits has an actual value that matches an expected value in view of the one or more test data patterns; and
identifying the one or more failed byte counter circuits in the first subset that are defective as those for which the actual value does not match the expected value.

14. The method of claim 8, further comprising:
performing one or more memory access operations on the memory array using the enabled failed byte counter circuits.

15. A memory device comprising:
a memory array comprising a plurality of memory cells arranged into a plurality of physical partitions; and
a plurality of failed byte counter circuits coupled to the memory array, wherein each of the plurality of failed byte counter circuits is associated with a different physical partition of the plurality of physical partitions, and wherein only a first subset of the plurality of failed byte counter circuits are enabled, while a remainder of the plurality of failed byte counter circuits provide redundancy for the first subset of the plurality of failed byte counter circuits.

16. The memory device of claim 15, wherein the plurality of physical partitions comprise sub-blocks of a plurality of blocks of a plane of the memory array.

17. The memory device of claim 15, wherein the first subset comprises 50% of the plurality of failed byte counter circuits.

18. The memory device of claim 15, wherein the first subset comprises 75% of the plurality of failed byte counter circuits.

19. The memory device of claim 15, further comprising:
control logic operatively coupled with the memory array and the plurality of failed byte counter circuits, wherein the control logic is to identify one or more failed byte counter circuits in the first subset that are defective and replace the one or more failed byte counter circuits with one or more failed byte counter circuits from the remainder of the plurality of failed byte counter circuits.

20. The memory device of claim 19, wherein to identify the one or more failed byte counter circuits in the first subset that are defective, the control logic is to:
generate one or more test data patterns to cause a program failure at least one of directly in the memory array or by manipulating a data register in a page buffer associated with the memory device and to cause an increment of the plurality of failed byte counter circuits;
determine whether each of the plurality of failed byte counter circuits has an actual value that matches an expected value in view of the one or more test data patterns; and
identify the one or more failed byte counter circuits in the first subset that are defective as those for which the actual value does not match the expected value.
